(19) United States
(12) Patent Application Publication
(10) Pub. No.: US 2026/0310496 A1
(43) Pub. Date: Oct. 8, 2026

(54) AI AGENT PLATFORMS

(71) Applicant: Panasonic Well LLC, Palo Alto, CA (US)

(72) Inventors: David Justus, Brooklyn, NY (US); Sandy Anuras, Seattle, WA (US); Anisha Kharkia, Palo Alto, CA (US); Sanjay Yadqirkar, Palo Alto, CA (US)

(21) Appl. No.: 19/339,599

(22) Filed: Sep. 25, 2025

Related U.S. Application Data
(60) Provisional application No. 63/783,632, filed on Apr. 4, 2025.

(51) Int. Cl. G06F 9/48; G06F 9/50; G06F 40/30

(52) U.S. Cl. CPC G06F 9/4881; G06F 9/5066; G06F 40/30

(57) ABSTRACT

An AI Agent Platform can facilitate execution of tasks. The AI Agent Platform may receive a request to execute a task from a computing device. The AI Agent Platform may classify an intent associated with the request. The AI Agent Platform may then execute a specialist module using an object derived from the request and the intent. The specialist module defines a sequence of subtasks that implement the task. The specialist module invokes one or more agent modules that are each configured to implement subtasks of the sequence of subtasks. The AI Agent Platform facilitates a presentation of a task response corresponding to execution of the task.

### CROSS-REFERENCE TO RELATED APPLICATIONS

The present application claims the benefit of U.S. Provisional Application 63/783,632 filed Apr. 4, 2025 and is related to U.S. Non-Provisional Application entitled “SYSTEMS AND METHODS FOR PROACTIVE ARTIFICIAL INTELLIGENCE” filed Sep. 25, 2025 (Attorney Docket No.: 109304-847304-008700US), U.S. Non-Provisional Application entitled “METHODS AND SYSTEMS FOR SELF-HEALING ARTIFICIAL INTELLIGENCE” filed Sep. 25, 2025 (Attorney Docket No.: 109304-854309-009700US), U.S. Non-Provisional Application entitled “GRAPHICAL EDITOR FOR COMPLEX ARTIFICIAL INTELLIGENCE AGENT SYSTEMS” filed Sep. 25, 2025 (Attorney Docket No.: 109304-852159-009800US) and U.S. Non-Provisional Application entitled “SYSTEMS AND METHODS FOR PROACTIVE RESPONSE GENERATION IN MULTI-USER SESSIONS” filed Sep. 25, 2025 (Attorney Docket No.: 109304-854311-009900US), each of which are incorporated herein by reference in their entireties and for all purposes.

### TECHNICAL FIELD

This disclosure relates generally to artificial intelligence platforms, and more particularly to artificial-intelligence platforms with dynamically reconfigurable components for general task facilitation.

### BACKGROUND

Artificial-intelligence (AI) systems process inputs to provide particular services to users. AI systems may be trained to perform a variety of tasks from image generation to programing. The performance of the AI systems may be related to the quality of the training data and the training processes of the AI system. The quality of the training data and the training processes can be managed during instantiation of the AI system. For example, training data can be managed through selection of datasets, feature selection, etc. The training process can be managed through various hyperparameters, accuracy metrics, and training methodologies (e.g., supervised learning, unsupervised learning, etc.). Generally, the more tasks that an AI system is configured to perform the more difficult the AI system is to train and the more likely performance of the AI system on discrete tasks degrades.

### SUMMARY

Methods are described herein for implementing a hierarchical AI processing system. The methods include receiving, from a computing device, a request to execute a task; classifying an intent associated with the request, wherein the intent provides context; executing a specialist module using an object derived from the request and the intent associated with the request, wherein the specialist module includes one or more machine-learning models that define a sequence of subtasks that implement the task; executing one or more agent modules configured to implement the subtasks of the sequence of subtasks, wherein each agent module is invoked by the specialist AI agent to implement one or more subtasks of the sequence of subtasks; and facilitating a presentation of a task response corresponding to execution of the task, wherein the task response includes a status the task.

The systems are described herein for implementing a hierarchical AI processing system. The systems may include one or more processors and a non-transitory computer-readable medium storing instructions that, when executed by the one or more processors, cause the one or more processors to perform any of the methods as previously described.

The non-transitory computer-readable media described herein may be configured to store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example AI Agent Platform trained for general task facilitation according to aspects of the present disclosure.

FIG. 2 illustrates a block diagram of example layers of an AI Agent Platform according to aspects of the present disclosure.

FIG. 3 illustrates a flowchart of an example orchestration layer of an AI Agent Platform according to aspects of the present disclosure.

FIG. 4 illustrates a flowchart of an example specialist module layer of an AI Agent Platform according to aspects of the present disclosure.

FIG. 5 illustrates a flowchart of an example implementation of an AI Agent Platform agent configured execute planning tasks according to aspects of the present disclosure.

FIG. 6 illustrates an example computing device architecture of an example computing device that can implement the various techniques described herein according to aspects of the present disclosure.

### DETAILED DESCRIPTION

Systems and methods are described herein for an Artificial-Intelligence (AI) Agent Platform that identifies tasks, implements strategic planning operations, and executes the strategic planning operations to implement the identified tasks. Conventional systems (e.g., software, AI systems, etc.) that are configured to operate autonomously are limited in the tasks they can perform. Conventional systems that perform varying tasks or a large quantity of tasks have significantly increased training requirements (e.g., data quantity, data type distributions, training iterations, etc.) and often results in lower quality and accuracy per task. The AI Agent Platform described herein include hierarchy of machine-learning models configured to process a large quantity of varying tasks with high accuracy and precision. In addition, the AI Agent Platform can dynamically reconfigure processing pipelines of discrete machine-learning models to support implementation of new tasks and task types at runtime.

The AI Agent Platform includes a set of machine-learning models that perform hierarchical task planning and execution based on states tracked throughout execution of task. An orchestration layer manages of the AI Agent Platform receives input from one or more external components. A specialist layer includes machine-learning models configured to perform one or more task types. Each specialist module defines a sequence of subtasks that can be executed to implement a task. The specialist module then invokes discrete agent modules that are each configured to implement individual subtask types. The AI Agent Platform utilizes this hierarchical task planning to execute complex tasks including tasks that AI Agent Platform has not been trained to execute. For example, the AI Agent Platform can define new specialist modules may combining different, existing agent modules enabling the new specialist machine machine-learning models to implement new tasks and subtasks.

The orchestrator layer processes input to the AI Agent Platform to detect possible tasks that can be facilitated by the AI Agent Platform. The input may be received from an internal and/or external component of such as, but not limited to, computing devices operated by users, computing devices operated by administrator agents, sensors or sensor data streams, specialist modules of the AI Agent Platform, and/or the like. The input may include natural language communications (e.g., audio segments, alphanumeric strings, etc.), audio segments, video segments, images, structed data, unstructured data, and/or the like. For example, the orchestrator layer may receive natural language communications from a computing device operated by a user. The orchestrator layer also receives scheduling information from a scheduler service. The scheduling information may pass information associated with a schedule of the user, a schedule of tasks and/or subtasks being executed, and/or the like to the orchestrator layer, which enables the orchestration layer to schedule execution of tasks and subtasks.

The orchestrator layer parses the received input to identify tasks. The received input may include words, phrases, commands, etc. that can be interpreted by the orchestrator layer as a task. In some instances, the orchestrator layer may proactively recommend tasks based on the received input. For instance, the user may converse with the AI Agent Platform and/or a user agent of the AI Agent Platform about a topic such as a particular location. The orchestrator layer may parse communications and identify a travel-based task associated with the particular location or an activity associated with the particular location. The AI Agent Platform may receive input from a variety of information sources include, but not limited to, sensors, wearable devices, Internet-of-Things (IoT) devices, etc. The orchestrator layer may use the information received from any information source (in addition to or in place of the received input) to identify tasks or to proactively recommend tasks to the user.

The orchestrator may analyze the input for topic segmentation (e.g., classifying topics associated with natural language communications, etc.), sentiment analysis (e.g., identifying tone, intent, contexts, and/or the like from natural language communications, etc.), contextual analysis (e.g., classifying related features or modifying features that are associated may related to the identified task, etc.), combinations thereof, and/or the like. The orchestrator layer may use the task, the topic segmentation, sentiment analysis, and contextual analysis to route the task to a particular specialist module configured to execute the task or a portion of the task. For example, if the task can be implemented by a particular specialist module, the orchestrator layer passes the task to the particular specialist module. The orchestrator layer may also pass task related details such metadata, state data associated with execution of related tasks, contextual data, any of the aforementioned information derived by the orchestrator layer, and/or the like. If the task cannot be implemented by a particular specialist module, the orchestrator layer divides the task into a set of discrete tasks that each be implemented by a specialist module and pass each discrete task to a respective specialist module. The orchestrator layer may also pass task related details such metadata, state data associated with execution of related tasks, contextual data, any of the aforementioned information derived by the orchestrator layer, and/or the like.

Specialist modules (also referred to the specialist layer) are trained to implement one or more task types or domains. The specialist modules includes a planning component that defines a sequence of subtasks that implement a task. The specialist module then invokes one or more agent modules to implement the task. The specialist module tracks a state of the task throughout implementation of the sequence of subtasks, which defines a state machine. The state may be tracked in real time throughout task and/or subtask execution. Specialist modules include self-healing processes that provide fault tolerance during task execution. During execution of each subtask and/or after execution of each subtask, the specialist module revaluates the sequence of subtasks to determine if execution of the task is still possible. For instance, the specialist module identifies failure states (e.g., subtasks that cannot be executed or that had an execution failure, whether future subtasks in the sequence are unlikely to execute correctly or result in execution of the task, etc.). If a current state of a task or subtask is a failure state, the specialist module defines a new sequence of subtasks that extend from the failed subtask to improve a likelihood that the task will be executed successfully.

The agent modules (also referred to as the skill layer) are trained to implement one or more discrete subtasks. In some instances, each agent module is trained to perform a single subtask type. The agent modules support internals services of the AI Agent Platform and external application programming interfaces (APIs). The agent modules handle error logic (e.g., error detection, exception handling, interrupt handling, etc.), retry logic (e.g., enabling recovery from errors, failure states, etc.), tool registry for handling new tools and libraries, and/or the like. For example, agent modules may dynamically invoke APIs to facilitate execution of subtasks by external services, retrieve information, transmit information, etc. For instance, an agent module trained to interact with a calendar service may generate commands using APIs to acquire calendar information on particular dates, modify the calendar, etc. Agent modules leverage small machine-learning models that are trained to implement the subtasks of the agent modules. In some implementations, the agent module may include techniques other than machine-learning such as a dynamically reconfigurable algorithms, hardcoding, APIs, etc. to implement the functionality of the agent modules described herein.

When execution of a subtask terminates (successfully or unsuccessfully), the agent module returns the execution details to the specialist module. If the execution of a subtask terminates unsuccessfully, the agent module may diagnose a cause for the execution failure and attempt remedial action such as executing the subtask again, requesting additional information (e.g., from a user, a representative, the specialist machine-learning mode, the orchestrator, combinations thereof, and/or the like), invoking an alternative agent module, and/or the like. For instance, if the subtask failed due to syntax error or unhandled exception, the agent module may execute the subtask again defining a new implementation of the subtask (e.g., a new API function or other function call, new programming instructions, accessing a same or different external service to implement the subtask, etc.). If agent module determines that the failure cannot be remediated, then the agent module reports the failure condition and information associated with the failure condition (e.g., such as, but not limited to, state information of the subtask, an indication of how much of the subtask was executed before the failure, an identification of any generated errors, an identification of a classified cause of the failure condition, combinations thereof, and/or the like). The specialist module may then execute remedial action by redefining the sequence of subtasks, assigning the subtask to another agent module, retraining the agent module, facilitating execution of the subtask, combinations thereof, and/or the like.

If the execution of a subtask terminates unsuccessfully, then the execution details are passed back to the specialist module. The execution details may include, but are not limited to, a state of the subtask, an identification of any errors or faults generated during execution of the subtask, an execution result (e.g., a derived value, a returned value from an external service, a status variable such as success/failure or 0/1, etc.), a timestamp associated with an execution start time, an elapsed execution time, resource consumption information (e.g., such as memory, processing cycles, network bandwidth, user resources, etc.), confirmation information from an external service, combinations thereof, and/or the like. For example, the subtask may be a request to book a flight to San Francisco. The agent module may execute the subtask and return a confirmation of the booked flight, an identification of the flight number, an identification of the departure time and airport, etc. to the specialist module.

The specialist module aggregates the execution details of subtasks of the sequence of subtasks defined by that specialist module. The specialist module then generates execution details for the task using the aggregated execution details of the subtasks of the sequence of subtasks. The execution details of the task are returned to the orchestrator layer. The orchestrator layer passes the execution details through a natural language generator, which translates the filing details into a communication that be returned to the user. In some instances, the orchestrator layer may include a safety layer that analyzes communications received from the user and communications to be transmitted to the user for unpermitted statements (e.g., statements associated with violence, discrimination, tasks or task types that are not supported by the AI Agent Platform, improper words or slang, etc.) incorrect statements (e.g., false statements, contradictions, etc.), and/or the like.

In an illustrative example, an AI Agent Platform may receive a request to execute task from a computing device. The request may include natural language communications received over a text-based communication channel (e.g., a web-interface, a user interface of an application executed by the computing device, instant messaging, direct messaging, text messaging, email, etc.), a voice-based interface (e.g., user interface of an application executed by the computing device, a telephone connection, a voice-assistant device, etc.), an audiovisual interface (e.g., video conferencing, etc.). The request may be direct (e.g., “Please book me a flight to Denver, Colorado on the morning of April 18.”) or indirect (e.g., I'd like to visit Denver some time”). Indirect requests may be parsed by the AI Agent Platform and classified according to a task type and task. If the AI Agent Platform does not have enough information to implement the classified task, the AI Agent Platform may request additional information from the computing device (e.g., over the same communication channel or another communication channel, etc.) or retrieve additional information accessible to the AI Agent Platform (e.g., such as any information or external sources that the computing device and/or the user thereof has been given authorization to access by the computing device and/or the user).

The AI Agent Platform passes the request and any additional information to an orchestration layer, which coordinates execution of the task by one or more specialist modules and/or agent modules. The orchestration layer may process the request through a safety layer that determines if the request can be satisfied by the AI Agent Platform (e.g., the task is executable by the AI Agent Platform, the task does not violate and processing restrictions, etc.).

The orchestration layer of the AI Agent Platform classifies an intent associated with the request. The intent associated with the request indicates a purpose of the request and/or task and provides a context for the orchestration layer to better execute the task in a way that is tailored to the user (e.g., using preferred terminology, preferred external services, etc.). The orchestration layer may also use the intent to route the task to particular agents (e.g., specialist modules, agent modules, etc.) and/or subagents to execute the task. For example, the request “Buy tickets to the baseball game tonight” may include an intent to attend a baseball game of a particular team near the user. The orchestration layer may then route the task to a specialist module configured to acquire tickets to events.

In some examples, the orchestrator layer includes one or more machine-learning models trained to predict one or more topics and/or one or more intents from the request. The one or more machine-learning models may output predicted topics and/or intents along with confidence values indicating a degree in which the output topics and/or intents fit the internal weights of the one or more machine-learning models. The confidence values are indicative of an accuracy of the predictions. The orchestrator layer may use the topics and/or intents that are greater than a threshold confidence to identify specialist modules that may execute the task.

The orchestrator layer of the AI Agent Platform executes a specialist module using an object (e.g., a feature vector, a data structure such as a JavaScript Object Notation (JSON) object, etc.) derived from the request and the intent associated with the request. In some examples. the specialist module may include one or more machine-learning models that define a sequence of subtasks that implement the task. In other examples, the specialist module may use deterministic techniques to define the sequence of subtasks based on an identification of the task, a task type corresponding the task, the intent, a topic, combinations thereof, and/or the like. In some examples, the object may be further derived from state information provided by the orchestrator layer. The state data may include information associated with tasks to be executed by two or more specialist modules. The state data may indicate information associated with the portion of the task to be executed by each specialist module. The state data may be passed to the specialist modules so that each specialist module may determine the execute state of the overall task as well as the execution state of other specialist modules.

Specialist modules may be configured to execute a discrete set of task types associated with a domain. The AI Agent Platform includes many different specialist modules that can be invoked to execute complex tasks. Each specialist module may include a planning component, a state component, and one or more subagents. The planning component breaks down tasks into subtasks and then defines a sequence of subtasks that when executed, implement the task. The planning component may also include a scheduler that coordinates execution of particular tasks or subtasks with other specialist modules that are executing other portions of a larger task. The state component tracks the state of the task and the sequence of subtasks. The state component may form a state machine for the specialist module usable to provide fault tolerant processing of tasks.

The subagents include instructions to implement particular subtasks and coordinate among agent modules that execute the subtasks. The subagents also include instructions for formatting execution details, generating communications (e.g., such as requests for particular information, execution details, etc.). In some examples, subagents may include machine-learning models to provide any of the aforementioned functionality. In other instances, subagents may include predefined instruction sets that may provide any of the aforementioned functionality. In still yet other examples, subagents may be configured by the one or more machine-learning models. The subagents may report intermediate state information (e.g., a current state of the task, an identification of which subtask of the sequence of subtasks is being executed, a state of the subtask being executed, etc.) to the specialist module and/or to the orchestrator.

The specialist module invokes an agent module to facilitate execution of a subtask of the sequence of subtasks. Agent modules may be configured to execute a single subtask type or a limited set of related subtask types. In some examples, the agent module includes instructions to facilitated execution of subtasks corresponding to the single subtask type or set of related subtask types. In other examples, the agent module includes a machine-learning model trained to facilitated execution of subtasks corresponding to the single subtask type or set of related subtask types.

The agent module includes access to one or more APIs usable to invoke internal services (e.g., services and/or functions of the AI Agent Platform, etc.) and/or external services (e.g., services external to the AI Agent Platform such as, but not limited to, web-based services, third-party services, remote computing devices, etc.). For instance, the APIs may be usable to access flight booking platform and book a flight for a user. Agent modules may be chained together by specialist modules to execute various subtasks that correspond to a task. Agent modules may also include error instructions (e.g., to generate and/or handle errors, exceptions, faults, interrupts, etc.), retry instructions (e.g., to restart a subtask upon detecting an error condition, a stalled condition, etc.), a tool registry (e.g., that stores information associated with libraries, APIs, tools, etc. that can be invoked by the agent module), and/or the like.

The specialist module may invoke agent modules based on a particular subtask of the sequence of subtasks. As a result, the specialist module may invoke the same agent module for each subtask or different agent modules for each subtask. The specialist module may execute the sequence of subtasks in series, partially in series and partially in parallel (based on dependencies of subtasks on other subtasks, etc.), or in parallel.

The agent module returns execution details corresponding to execution of the subtask. If there is another subtask in the sequence of subtasks, then the specialist module invokes an agent module (e.g., the same agent module or another agent module depending on a subtask type associated with the next subtask) to execute the next subtask in the sequence. If there are no other subtasks in the sequence of subtasks, the specialist module defines a task response based on the execution details of each subtask. The task response indicates a status of executing the task (e.g., success, failure, etc.), a state of the task, information generated when executing the task (e.g., information returned from external services, summary of a result of executing the task, alphanumeric data, etc.), combinations thereof, and/or the like. The specialist module returns the task response to the orchestrator layer.

For example, a request to execute a task may include a travel request such “I want to visit Denver in September.” The specialist module may define the sequence of subtasks that include a first subtask to acquire calendar information from a calendar service associated with the user, a second subtask to acquire preference of the user (e.g., directly from the user through a communication request, stored preferences, preference generated from previous interactions with the AI Agent Platform, etc.), a third subtask to identify candidate flights based on the calendar and preferences of the users, a fourth subtask to identify candidate hotels based on the calendar and preferences, a fifth subtask to identify potential activities in Denver based on the calendar and preferences, etc. The task response may include a complete itinerary for a trip to Denver sometime in September based on the availability of the user (as determined by the user's calendar).

The orchestrator layer of the AI Agent Platform facilitates a presentation of the task response corresponding to execution of the task. The task response may include a status the task. For example, if the task executed successfully, the task response may indicate the task executed successfully and provide details of the executed task (e.g., task details, etc.). If the task did not execute successfully, the task response may include an indication of why the task failed, which subtask caused the task to fail, an identification of one or more errors generated, etc. The orchestrator layer may include a natural language generator configured to generate natural language communications to communicate the task response to the user. The natural language generator may generate communications based on the communication channel over which the request was received. That is, if the request is received via instant messaging, the task response may be communicated over instant messaging. Alternatively, the task response may be communicated over another communication channel (e.g., such as any of the aforementioned communication channels). The communications generated by the natural language generator may be processed by the safety layer before being transmitted to the computing device to ensure the generated response is safe to transmit (e.g., does not violate any content restrictions such as improper words or phrases, topics, etc.). Once presented to the user, the AI Agent Platform may standby for further input (e.g., to execute further tasks, etc.) from the computing device.

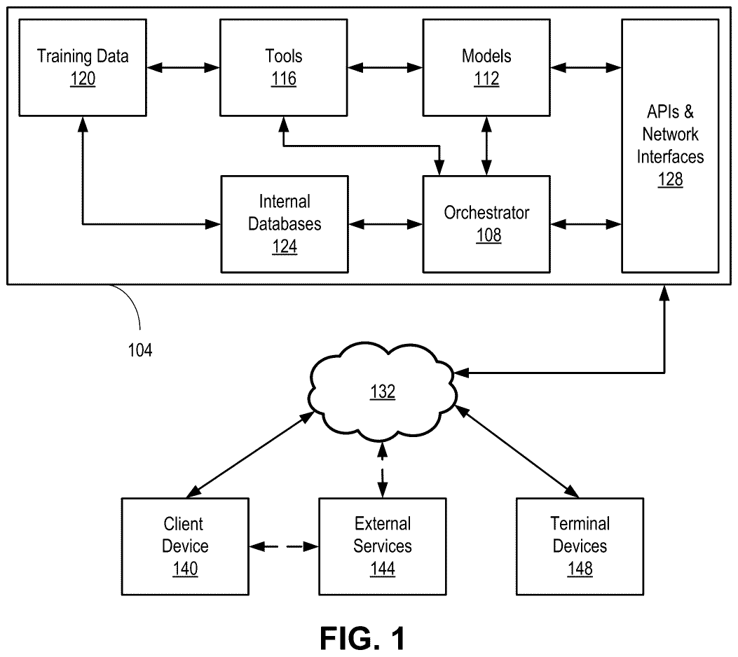

FIG. 1 illustrates a block diagram of an example AI Agent Platform trained for general task facilitation according to aspects of the present disclosure. AI Agent Platform 104 may operate as a hardware platform (e.g., as an application specific integrated circuit (ASIC), field programmable gate array (FPGA), special-purpose processing device, combinations thereof, and/or the like), a software platform (e.g., executing on a computing device, server, cloud network, a hardware platform as previously described, combinations thereof, and/or the like), or as a combination of a hardware platform and a software platform.

AI Agent Platform 104 may include orchestrator 108, which may manage communications with remote devices, identify tasks, generate and manage communications with external devices, facilitate task planning and execution and/or the like. Orchestrator 108 may receive communications from one or more external devices via APIs and network interfaces 128. APIs and network interfaces 128 may include one or more interfaces, libraries, and/or the like that enable AI Agent Platform to autonomously access and/or communicate with remote devices (e.g., such as, but not limited to, any of the aforementioned devices, etc.). APIs and network interfaces 128 is configured to translate communications into a native format such as translating received communications into a native format of AI Agent Platform 104 and/or translating communications transmitted from AI Agent Platform 104 into a native format of the receiving device. APIs and network interfaces 128 may also include interfaces that facilitate access to functions of other devices (e.g., such as, but not limited to, APIs exposed by the other devices, etc.), which enable AI Agent Platform 104 to autonomously access and/or manipulate remote devices.

Orchestrator 108 is configured to communicate with users using natural language communications, identify tasks within natural language communication, and execute identified tasks. For example, client device 140 may connect to AI Agent Platform 104 via APIs and network interfaces 128 and establish a communication session between orchestrator 108 and client device 140. The communication session may text-based, audio-based, and/or audiovisual-based. Orchestrator 108 may establish communication session or receive communication from other external devices such as, terminal devices 148 (and/or the users thereof, which are referred to herein as agents), external services 144, and/or the like via APIs and network interfaces 128. External services 144 may include services associated with client device 140 and/or the user thereof, services that may provide information or facilitate execution of tasks or subtasks, combinations thereof, and/or the like. Examples of external services include, but are not limited to, information sources (e.g., databases, webpages, services subscribed to by the user, etc.), e-commerce platforms, home automation devices, Internet-of-Things devices, wearable devices, sensors, subscription services, combinations thereof, and/or the like.

Client device 140 may establish a communication session with orchestrator 108 may to enable access to services provided by orchestrator 108. The communication session may be an environment through which real-time and/or non-real-time communications can be exchanged between client device 140 and AI Agent Platform 104. In some examples, orchestrator 108 may include an automated communication service that may communicate with client device 140 via the communication session. In other examples, the automated communication service may be a component of tools 116 and access by orchestrator 108. The automated communication service may process natural language communications in any format (e.g., alphanumeric text, audio segments, video segments, and/or the like). In some instances, the automated communication service may include one or more models that can parse communications and generate responses (e.g., such as natural language models, large language models, etc.). In other instances, the automated communication service may include non-machine-learning algorithms, which may use less processing resources at the expense of more limited communication functionality. The automated communication service may include a classification layer that may identify tasks within communications, assign a task category to identified tasks, perform semantic/lexical analysis on communications (e.g., to identify user intent, intensity (e.g., tonal analysis, etc.), mood, combinations thereof, and/or the like), combinations thereof, and/or the like.

Upon establishing a communication session with client device 140, orchestrator 108 may retrieve any relevant information associated with client device 140 and/or the user thereof to enhance a context of services provided by AI Agent Platform 104 and to provide more relevant recommendations to client device 140 and/or the user thereof. For example, orchestrator 108 may retrieve a family profile associated with client device 140 and/or the user thereof. The family profile may include information known about the user including, but not limited to, information received from the user, communications between the user and AI Agent Platform 104 (e.g., such as communications with orchestrator 108, terminal devices 148, etc.), task facilitated by AI Agent Platform 104, information associated with the user (e.g., information generated through operations of AI Agent Platform 104, etc.), demographic information, family information, combinations thereof, and/or the like. AI Agent Platform 104 may add to the family profile each time there is an interaction with the user, information associated with the user is generated by AI Agent Platform 104, and/or information associated with the user is received by AI Agent Platform 104. The family profile may be used to tailor operations of AI Agent Platform 104 to the user, which may modify how communications are generated and/or transmitted, how tasks are recommend and/or executed, etc. If no family profile can be identified, then orchestrator 108 may identify a family profile associated with a related user to the user (e.g., such as family member, etc.), which may include references to the user. If no such family profile can be identified, then orchestrator 108 may instantiate a new family profile by requesting predetermined information from the user. Orchestrator 108 may retrieve other information associated with client device 140 and/or the user thereof in addition to or in place of the family profile such as, but not limited to, information stored by client device 140 and/or associated with client device 140, external services such as services subscribed to by a user of client device 140, sensors connected to or associated with client device 140, IoT devices connected to or associated with client device 140, home automation devices connected to or associated with client device 140, or any other data source.

AI Agent Platform 104 may include one or more machine-learning model that provide some of the operations of AI Agent Platform 104 such as automated communication services, identification of tasks and/or events, processing real-time and non-real time data streams, generating implementations of tasks and/or events, combinations thereof, and/or the like. In some examples, AI Agent Platform 104 may include one or more machine-learning models in models 112. Models 112 may store models directly operated by orchestrator 108, specialist modules, and/or agent modules. Orchestrator 108 may be configured to instantiate, train, manage, and/or the like the machine-learning models of models 112. For example, when a new agent module is needed, orchestrator may instantiate the agent module (from a new model or an existing model) and train the agent module according to the task the agent module is to perform.

Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

Orchestrator 108 may train the one or more machine-learning models using historical operations of AI Agent Platform 104, the family profile associated with client device 140, communications of the client device 140, procedurally and/or manually generated data, data from one or more databases, web-based data (e.g., from a web-crawler, etc.), combinations thereof, and/or the like. For example, orchestrator 108 may store information received from client device 140, information associated with client device 140 and/or the user thereof, etc. in internal databases 124. AI Agent Platform 104 may use the information to define a family profile of the user in internal databases 124. The family profile may also include information associated with one or more related users such as users that are related to the user (e.g., family, friends, etc.), users in a same household, etc. In some instances, the machine-learning models of models 112 may be trained to be generally applicable (e.g., user agnostic, etc.) to enable the models to be usable for different users. In those instances, the family profile may not be used in training. Alternatively, the family profile of different users may be used in the training of the machine-learning models.

AI Agent Platform 104 may use small interchangeable machine-learning models that can be reconfigured to provide complex tasking. AI Agent Platform 104 may first instantiate the models of the orchestrator 108 (e.g., to provide natural language processing, task management, scheduling, etc.). AI Agent Platform 104 may then instantiate one or more specialist modules based on tasks to be managed by AI Agent Platform 104. Each specialist module may invoke one or more agent modules that may execute individual subtasks defined by the specialist module. As AI Agent Platform defines specialist modules, AI Agent Platform may instantiate agent modules that will be invoked by each specialist module. Specialist modules and agent modules may each include machine-learning models trained according to the tasks (or subtasks) to be executed by each respective specialist modules and agent modules. Specialist modules, for example, may be include machine-learning models trained to plan the execution of tasks, including subdividing tasks into sequence of subtasks, redefining sequence of subtasks upon detecting failure conditions, identifying agent modules to execute subtasks, tracking a state of the task, etc. In some instances, specialist modules may also include sub-agents (e.g., that may provide planning of subtasks subdividing subtasks into sequences of subtasks, etc.). Agent modules may include machine-learning models and/or processes that implement discrete subtasks. In some instances, agent models may execute a single type of subtask. In other instances, agent models may execute two or more types of subtasks. Orchestrator 108 and/or specialist modules may chain agent modules to implement complex subtasks or tasks. Orchestrator 108 and/or specialist modules may also rearrange agent modules to provide varying functionality.

Orchestrator 108 may parse input from client devices. The input may include natural language communications (e.g., audio segments, alphanumeric strings, etc.), audio segments, video segments, images, structed data, unstructured data, and/or the like. For instance, the input may include natural language inputs. Orchestrator 108 may classify inputs to identify tasks and a corresponding task type. Orchestrator 108 may invoke a specialist module configured to process the detected task type. The specialist module may parse the task type and generate a set of subtasks that when executed, implement the task. The set of subtasks may include sequences of subtasks (e.g., defined for serial processing), collections of tasks (e.g., defined for serial or parallel processing), and/or combinations thereof. For instance, some subtasks may be dependent on other subtasks causing the subtasks to execute sequentially. Other subtasks may not include dependencies or may only be dependent on some subtasks. These subtasks may be executed in parallel with other subtasks. The specialist modules may define an execution order that includes sequential and/or parallel subtask execution. The execution order may be based primarily on dependencies but may also be based on execution efficiency (e.g., execution rate, resource utilization, etc.) or execution security (e.g., fault tolerance, etc.). For instance, the specialist module may define the execution order of subtasks according to dependencies, then optimize the execution order to improve an execution rate (e.g., by executing any non-dependent-based subtasks in parallel with other subtasks), resource utilization (e.g., by executing subtasks sequentially to reduce a processing resource utilization, etc.), execution security (e.g., by executing subtasks in an order that reduces a likelihood of generating faults or in an order in which recovering from a fault is more likely, etc.), combinations thereof, and/or the like.

In some instances, orchestrator 108 and/or specialist modules may determine that a task cannot be divided into subtasks. In those instances, orchestrator 108 or the specialist module may execute the task directly (e.g., without invoking an agent module, etc.). For instance, client device 140 may transmit a natural language communication including a query for information. Orchestrator 108 may determine that orchestrator 108 is capable of structuring a query to an information source (e.g., a database, the Internet, etc.) and generate a natural language response including the requested information. Alternatively, orchestrator 108 may pass the query to a specialist module and the specialist module may determine that the task can be executed directly by the specialist module without passing the task an agent module.

Orchestrator 108 may determine whether to execute a task directly or to invoke a specialist module to execute task. For instance, orchestrator 108 may include a classifier and/or decisioning module configured to determine how to route tasks including tasks that can be executed directly by orchestrator 108. In some instances, orchestrator 108 may execute any task that orchestrator 108 is capable of executing directly and invoke specialist modules for tasks that orchestrator 108 cannot execute directly. In other instances, orchestrator 108 may determine whether to execute tasks directly or to invoke a specialist module based on execution efficiency, execution security, and/or the like. For instance, orchestrator 108 may determine when to pass tasks that can be executed by orchestrator 108 directly to maximize an execution rate, etc. In still yet other instances, orchestrator 108 may pass all tasks to specialist modules regardless of whether orchestrator 108 is capable of executing a task directly.

In some instances, specialist modules may execute any task received from orchestrator 108 that the specialist modules are capable of executing directly. A specialist module may invoke agent modules for tasks that the specialist module cannot execute directly. In other instances, specialist modules may determine whether to execute a task directly or to invoke an agent module to execute the task based on execution efficiency, execution security, and/or the like. For instance, a specialist module may execute a task directly upon a determination that doing so will increase a task execution rate, or reduce processing resource utilization, etc. In still yet other instances, the specialist module may pass all tasks to agent modules regardless of whether specialist module is capable of executing a task directly.

Training data 120 may include the evaluation data from tools 116 and data from internal databases 124. Orchestrator 108 may define training datasets from tools 116. The training datasets may be defined based on the type of machine-learning model being trained, the training algorithm (e.g., supervised learning, unsupervised learning, semi-supervised learning, metalearning, transfer learning, etc.), and the tasks or subtasks to be executed by the machine-learning model being trained. Orchestrator 108 may use the training datasets to train the machine-learning models of models 112. The machine-learning models of models 112 (e.g., such as the models of orchestrator 108, specialist modules, agent modules, etc.) may be evaluated by tools 116 (e.g., accuracy metrics, operations data, user feedback, admin user feedback, etc.), feedback from client device 140 and/or the user thereof, terminal devices 148 and/or the users thereof, and/or the like.

The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

In some example operations of AI Agent Platform 104, the user of client device 140 may request various services of AI Agent Platform 104 over the communication session. For example, client device 140 may request implementation of a task (e.g., such as, but not limited to, acquisition of a product or service, implementation of an experience, etc.). Orchestrator 108 may process the communication to identify the task. Orchestrator 108 may retrieve additional information associated with the user and the task such as, but not limited to, the family profile, scheduling information, sentiment analysis to determine an intent associated with the task, combinations thereof, and/or the like. Orchestrator 108 may select a specialist module from models 112 that may be configured to execute the task. Orchestrator 108 may then transmit an identification of the task and the additional information to the selected specialist module. The specialist module receives the task and define a sequence of subtasks that will implement the task. The specialist module then invokes a first agent module that is configured to implement the first subtask. When the first subtask completes, the specialist module may invoke the next subtask. This process may continue into each of the subtasks are complete or the specialist module determines the task is complete. The specialist module may return a task response (e.g., confirmation of task execution, summary of task execution, etc.) to orchestrator 108 and orchestrator 108 may report the task response to client device 140 (e.g., using natural language communications, etc.).

Specialist modules may be self-healing to provide fault tolerant processing of tasks. For example, specialist modules may subdivide tasks into a sequence of subtasks. If a subtasks terminates in a failure condition (e.g., an error is detected, agent module cannot execute a subtask, missing information, etc.), the specialist modules can execute the subtask (e.g., using a same or different agent module) and/or re-executes the planning stage be redefining the sequence of subtasks (beginning after the failed subtask) based on the failed subtask. The new sequence of subtasks may be better able to execute the task in view of the failure condition. The specialist module may generate a new sequence of subtasks each time a failure condition is detected in a subtask. In some examples, if the same or similar subtask terminates in a failure condition more than a threshold number of times, the specialist module may automatically connect a terminal device of terminal devices 148. Terminal device may be configured to execute subtasks directly, provide missing information for the subtasks, reconfigure agent modules, interact with client device 140, combinations thereof, and/or the like. For instance, a subtask may terminate in a failure condition because an external service only takes orders verbally over a telephone. The specialist module may connect to a terminal device to enable the terminal device to execute the subtask by calling the external service and completing the order. Upon successful termination of the subtask, the specialist module may invoke the next agent module to implement the next subtask in the sequence and the terminal device may be disconnected. Alternatively, the specialist module may identify a different external service that can be executed by the agent module and execute the re-execute the subtask.

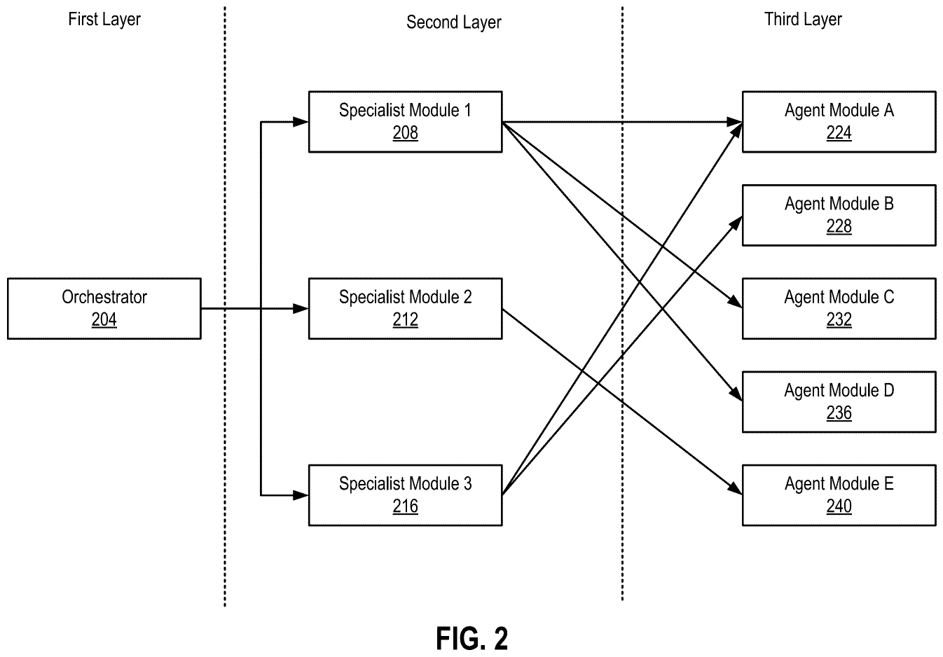

FIG. 2 illustrates a block diagram of example layers of an AI Agent Platform according to aspects of the present disclosure. The AI Agent Platform described herein may implement three or more task facilitation layers for task identification, task planning, and task execution. Orchestrator 204 represents a first task facilitation layer. Orchestrator 204 may receive input associated with tasks. The input may include natural language communications (e.g., audio segments, alphanumeric strings, etc.), audio segments, video segments, images, structed data, unstructured data, and/or the like. The input may include a request or task to be executed by the AI Agent Platform. For example, orchestrator 204 may include a natural language processor configured to parse natural language input (e.g., text-based and/or speech-based, etc.), classify tasks within the natural language input, perform sematic/lexical classification (e.g., to identify mood, intent, meaning, etc.), classify tasks from notifications or alerts, classify tasks from data streams (e.g., such as sensor data, etc.), combinations thereof, and/or the like. The natural language processor, task classifier, semantic/lexical classier, etc. may be implemented algorithmically and/or via one or more machine-learning models (e.g., such as, but are not limited to, support vector machines Bayesian networks, neural networks, deep learning networks, clustering models (e.g., random forest, K-means, etc.), latent semantic indexing, any of the aforementioned models described in connection to FIG. 1, combinations thereof, and/or the like).

In some instances, orchestrator 204 may route the classified tasks to the second task facilitation layer (e.g., the specialist modules). The second layer of the AI Agent Platform may include one or more specialist modules such as specialist module 1 208, specialist module 2 212, and specialist module 3 216 (as shown). The AI Agent Platform may instantiate any number of specialist modules in addition to those shown. In some instances, the AI Agent Platform may instantiate fewer specialist modules. For example, upon classifying a first task, the AI Agent Platform may instantiate a specialist module 1 208 to execute the task. At that moment, the AI Agent Platform may include a single specialist module. The AI Agent Platform may instantiate additional specialist modules to execute new task types as the new tasks are identified by orchestrator 204.

The specialist modules are configured to plan execution of tasks received from orchestrator 204. The planning component of a specialist module may divide tasks into a sequence of subtasks that when executed implement the task. The subtasks may be executed by the specialist module, another specialist module, and/or the third layer of the AI Agent Platform (e.g., the agent modules, etc.). Specialist modules track the state of each subtask and the overall task throughout task execution. The state enables forward propagation of features from previous subtasks, detection and remediation of failure conditions, replanning, etc. For example, the state may be used to replan tasks and/or subtasks (e.g., without re-executing successful subtasks, etc.), reorder sequences of subtasks for resource efficiency or time efficiency, schedule execution of subtasks, and/or the like. For instance, if a subtask terminates in a failure condition (e.g., execute unsuccessfully, resulted in an error, etc.), the specialist module may define a new sequence of subtasks based on the state so that the new sequence of subtasks begin after the subtask that resulted in the failure condition. The specialist module may use features derived from the failure condition to define the new sequence of subtasks so that the new sequence of subtasks is more likely to be executed successfully. Specialist modules may include or have access to one or more machine-learning models configured to divide subtasks into subtasks that will execute the task, schedule execution of subtasks (e.g., such as defining an execution order, an execution time, etc.), identify execution requirements (e.g., such as information needed to execute tasks or subtasks), interface with internal and/or external services to obtain missing information, and/or the like.

The third layer of the AI Agent Platform includes one or more agent modules such as agent module A 224, agent module B 228, agent module C 232, agent module D 236, and agent module E 240 (as shown). The AI Agent Platform may instantiate any number of agent modules in addition to those shown. In some instances, the AI Agent Platform may instantiate fewer agent modules. The AI Agent Platform may instantiate additional agent modules to execute new subtask types as the new subtasks are define by orchestrator 204 and/or specialist modules.

Agent modules may be configured to execute particular task or subtask. In some instances, agent modules may be configured to execute a single task or subtask. The AI Agent Platform may include multiple agent modules that can be invoked from different specialist modules. For instance, specialist module 1 208 may define a sequence of subtasks that may be executed by agent module A 224, agent module C 232, and agent module D 236. Specialist module 2 212 may invoke agent module E 240 to execute the task assigned to specialist module 2 212. Specialist module 3 216 may define a sequence of subtasks that may be executed by agent module A 224 and agent module B 228.

Agent modules may include processes and/or machine-learning models that execute the subtasks assigned to an agent module. In some instances, the processes and/or machine-learning models may be configured to access external services to execute tasks. In those instances, the agent modules may include APIs and/or other interfaces for accessing the external services. In Alternatively, or additionally, the agent models may define new API's interfaces, and/or libraries usable to access external services. Alternatively, or additionally, agent modules may access APIs, code libraries, and/or other interfaces within a repository of AI Agent Platform. The repository may be a single point of access for the APIs, code libraries, and/or other interfaces. The repository may allow agent modules to access the APIs, code libraries, and/or other interfaces without duplicating the APIs, code libraries, and/or other interfaces or creating references to APIs, code libraries, and/or other interfaces that may expose the APIs, code libraries, and/or other interfaces.

Agent modules may operate as a pool of resources that can be accessed by any specialist module. When a specialist module defines a new subtask type, the AI Agent Platform may first determine if there is an agent module capable of executing the subtask type. If not, then the AI Agent Platform may instantiate a new agent module (e.g., added to the third layer). Specialist modules can access any agent module allowing for efficient resource allocation and preventing wasteful instantiation of duplicate agent modules. Orchestrator 204 may include a scheduler that may prevent an agent module from being accessed by different specialist modules at the same time. The scheduler may lock agent modules when the agent module receives a subtask. Specialist modules may not access locked agent modules. If a specialist module attempts to invoke a locked agent module, the specialist module may either wait for the agent module to be unlocked, invoke another agent module that is configured to execute the subtask, or execute a different subtask while waiting for the agent module to be unlocked. In some instances, in addition to or in place of a scheduler, the AI Agent Platform may implement a queue within each agent module. If an agent module receives a new subtask while execute an existing subtask, the agent module may queue the new subtask. The agent module may execute the new subtask once the existing subtask terminates.

In some implementations, the AI Agent Platform may include additional layers between the first layer and the third layer, between the second layer and the third layer, before the first layer, or after the third layer. For example, the AI Agent Platform may instantiate an additional layer of specialist modules that interact with other specialist modules and/or the agent modules. Orchestrator 204 may route a task to a first specialist module which may define a sequence of subtasks that may be too complex to be executed by agent modules. Instead, the first specialist module may invoke one or more second specialist modules to execute the sequence of subtasks. Each second specialist module may receive a subtask and divide the subtask into a sequence of smaller subtasks that may be executed by an agent module (or further processed by a specialist module). The AI Agent module may include any quantity of specialist layers between orchestrator 204 and the layer of agent modules.

In some instances, orchestrator 204 may determine that task can be executed by orchestrator 204. For instance, orchestrator 204 may determine that a task cannot be divided into subtasks or that orchestrator 204 is capable of executing the task directly (e.g., the task is simple or includes few operations to complete, etc.). In those instances, orchestrator 204 may execute the task directly (e.g., without invoking a specialist module, etc.). Orchestrator 204 may determine whether to execute a task directly or to invoke a specialist module to execute the task. For instance, orchestrator 204 may include a classifier and/or decisioning module configured to determine how to route tasks including tasks that can be executed directly by orchestrator 204. In some instances, orchestrator 108 may execute any task that orchestrator 204 is capable of executing directly and invoke specialist modules for tasks that orchestrator 204 cannot execute directly. In other instances, orchestrator 204 may determine whether to execute tasks directly or to invoke a specialist module based on execution efficiency, execution security, and/or the like. For instance, orchestrator 204 may determine when to pass tasks that can be executed by orchestrator 204 directly to maximize an execution rate, etc. In still yet other instances, orchestrator 204 may pass all tasks to specialist modules regardless of whether orchestrator 108 is capable of executing a task directly.

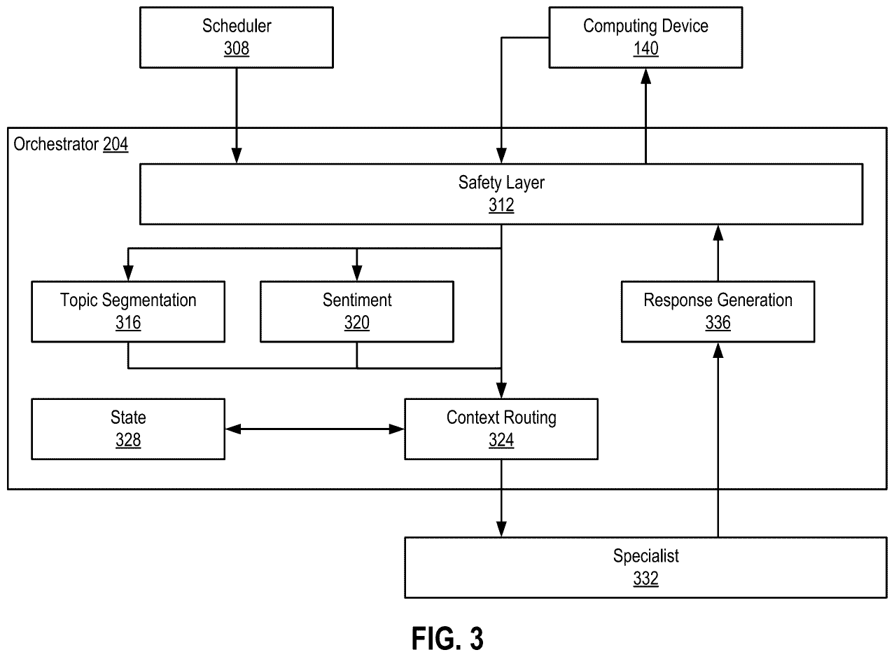

FIG. 3 illustrates a flowchart of an example orchestration layer of an AI Agent Platform according to aspects of the present disclosure. The orchestration layer of an AI Agent Platform includes orchestrator 204 (e.g., as previously described in connect to FIG. 2 and/or another instance of an orchestrator, etc.). Client device 140 may be operated by a user interacting with the AI Agent Platform. Client device 140 may be external from the AI Agent Platform (e.g., communicating over a network, etc.) or a terminal of the AI Agent Platform. Client device 140 may transmit a communication to orchestrator 204 of the AI Agent Platform. The communication may include an identification of a task to be executed by the AI Agent Platform. Orchestrator 204 may also receive scheduling information from scheduler 308 including, but not limited to, scheduling information associated with client device 140 and/or the user thereof, scheduling information associated with tasks being executed, scheduling information associated with the communication, combinations thereof, and/or the like.

Orchestrator 204 may first process communications through safety layer 312. Safety layer may process communications to determine if the communications can be processed by orchestrator 204 and whether the communications violate and particular rulesets or requirements (e.g., such as words or phrases that may be violent, dangerous, vulgar, restricted, etc.). If safety layer 312 identifies a safety violation, then the AI Agent Platform enters a deterministic workflow based on the safety violation. For instance, the deterministic workflow may include one or more requesting an alternative communication from client device 140 and/or the user thereof that does not violate the safety layer, reporting the safety violation, doing nothing, connecting client device 140 and/or the user thereof to one or more terminal devices (e.g., such as terminal devices 148, etc.) and/or the user thereof, combinations thereof, and/or the like. If the communication passes the safety layer, then processing continues.

The safety layer may pass the input to topic segmentation 316, sentiment 320 and context routing 324. Topic segmentation 316 may classify a topic within the input. The classification may be performed by keyword matching (e.g., matching words within the input to keywords associated with predetermined topics, etc.) or via a classifier model. The classifier model may be trained to predict a classification of an input vector comprising an alphanumeric string (e.g., the input received from client device 140 and other additional features derived from the input and scheduler 308, etc.). Sentiment 320 analyzes the input to identify an intent. Sentiment 320 may also use keyword matching to predefined intents and/or a classifier model.

Context routing 324 may retrieve a state (e.g., from state 328) associated with client device 140 and/or the user thereof, and the AI Agent Platform (e.g., such as tasks currently being executed, etc.). The state may include a conversational state (e.g., between the user and the AI Agent Platform, between the user and the user of a terminal device, and/or the like) that may provide context for task identification, routing of tasks to specialists, etc. Context routing 324 then routes the received task based on the topic, the intent, and the state of the AI Agent Platform to an appropriate specialist (e.g., specialist module 332 in this example). Context routing 324 routes tasks to the specialist module that may be capable to execute the task. In some examples, specialist modules may be associated with a particular topic and/or intent. Context routing 324 may select a specialist module based on the topic. For example, a task may be a request to plan a trip to Denver. Topic segmentation 316 may identify the topic as “Travel” and the intent as “plan a trip”. Context routing 324 may route the task to a travel-based specialist module. Context routing 324 may further use state information to select available specialist modules for load balancing the AI Agent Platform.

If a particular specialist cannot be identified by context routing 324 (e.g., based on the topic, intent, and/or the task not being associated with a particular specialist, specialists are not available, etc.), then context routing 324 may connect computing to one or more terminal devices (e.g., such as terminal devices 148, etc.) and/or the user thereof and the terminal device (or user thereof) may process the task for the user. For example, a user may input a task request for rewiring a television, which may not be within the capability of a current specialist module. In response, context routing 324 may request a new specialist module to be instantiated, which is capable of executing the task. Alternatively, context routing 324 may route the task to a terminal device and/or transmit a communication to client device 140 indicating the task cannot be executed.

Specialist module 332 may execute the task by subdividing the task into a sequence of subtasks and invoking one or more agent modules to execute each subtask. For example, returning to the previous example of planning a trip to Denver, a first subtask may be retrieving calendar information from client device 140 (or an external service storing such information). Alternatively, the first subtask may be to request additional information from client device 140 and/or the user thereof such as user availability, travel dates, user preferences (e.g., for seat selection, preferred flight times or routes, preferred airline, hotel preferences, activities, etc.), combinations thereof, and/or the like. A second subtask may retrieve flight information based on the information retrieved by the first subtask. A third subtask may retrieve hotel information. A fourth subtasks may identify activities that may be of interest to the user (e.g., attractions, meals, etc.). Specialist module 332 may invoke one or more agent modules that are capable of execute each subtask. Specialist module 332 may then aggregate the results from the agent modules into a task response return the task response to response generation 336.

Response generation 336 may generate a natural language response to the task using the task response. The natural language response may provide details regarding the execution of the task. The details may be based on the task that was executed and the how the task was executed. For example, for a task to plan a trip to Denver, the details may list of possible flights and costs, a list of possible hotels and costs, a list of possible activities and costs, etc. For a task to book a flight to Denver, the details may include ticket information for a flight to Denver (acquired by the agent module, etc.). Thus, some tasks and/or subtasks may be executed to generate information for the user (and/or other tasks or subtasks, etc.). The details for those tasks may include the generated information. Other tasks may generate a tangible result such as acquire objects or services, etc. The details for those tasks may include confirmation of the acquisition of the object and/or service (e.g., tracking numbers for mailed objects, serial numbers of acquired objects, confirmation webpages generated upon checkout or acquisition, receipts, etc.).

Response generation 336 may generate the natural language communications using a machine-learning model (or two or more machine-learning models, ensemble models, etc.) trained to generate alphanumeric natural language communications. In some examples, the machine-learning model may include a text-to-speech engine as a final layer enabling generated natural language communication to be presented as synthetic speech.

The machine-learning model may be trained to generate communications that correspond with a personality and/or with a particular tone (e.g., cheerful, formal, frank, edgy, etc.). The -learning model may be any of the aforementioned machine-learning models and trained using natural language communications (e.g., text and/or speech, etc.) provided by client device 140 and/or the user thereof, other computing devices and/or the users thereof, terminal devices 148 and/or the users thereof, a repository of natural language communications, historical communications between users and the AI Agent Platform, any combination thereof, and/or the like. The machine-learning models may first undergo an initial training process for general natural language generation. Once the initial training is completed, the machine-learning model may undergo a second training process. In some examples, the second training process may be a reinforcement-learning-based process that generates multiple versions of the machine-learning model with each machine-learning model having a different personality or using a different tone. Each version of the machine-learning model may be generated by executing the reinforcement-learning-based process using a same input dataset with different feedback or with a different input dataset. Alternatively, or additionally, response generation 336 may generate different versions of the machine-learning model by adding additional hyperparameters to bias training of the machine-learning model towards a particular personality and/or tone.

In some examples, the weights at each (activation) layer of each version of the machine-learning model may be extracted. The set of weights of each version of the machine-learning model may be compared to the set of weights of another version of the machine-learning model (or the version of the machine-learning model after the completion of the first training process) to define a delta set of weights (e.g., the difference between the sets of weights) for that machine-learning model. The delta set of weights may be associated with the tone or personality of the machine-learning model it was derived from. In some examples, a new set of weights may be derived from a linear combination of two or more sets of weights to create hybrid tones and/or personalities such as frank and cheerful, etc.

In other examples, the AI Agent Platform executes inference on the model using a set of positive inputs from the user (and/or inputs generated to simulate a user) and negative inputs from the user (and/or inputs generated to simulate a user). Positive inputs may include inputs that correspond to particular positive emotion, mood, state of mind, etc. such as happy, excited, etc. negative inputs may include inputs that correspond to particular negative emotion, mood, state of mind, etc. such as angry, sad, etc. For each set of inputs, the AI Agent Platform may average the activation function at each layer, which defines a positive vector for the positive inputs and a negative vector for the negative inputs. The positive vector and negative vector may be masked against each other to create a steering vector. At runtime, the steering vector may be applied to the model to set weights that correspond to how positive or how negative the model output should be. In some examples, multiple sets of positive inputs may be defined with each set of positive inputs corresponding to a particular emotion, mood, and/or state of mind. And multiple sets of negative=inputs may be defined with each set of negative inputs corresponding to a particular emotion, mood, and/or state of mind. The AI Agent Platform may then define multiple vectors (with each corresponding to a particular emotion, mood, and/or state of mind), which may be used to generate a steering vector usable to generate communications that correspond to particular emotions, moods, and/or state of minds or composite emotions, moods, and/or state of minds.

At runtime, response generation 336 may select a particular tone or personality and retrieve the corresponding delta set of weights that correspond to the selected tone or personality. The selection may be based on a previous iteration of the AI Agent Platform, such as, but not limited to, a previous task executed for client device 140 and/or the user thereof, a predicted likelihood that client device 140 and/or the user thereof will prefer the selected tone or personality. and/or the like. Alternatively, response generation 336 may receive a selection of a particular tone or personality (e.g., from client device 140 and/or the user thereof, a terminal device, an administrator, and/or the like). At runtime, the delta set of weights corresponding to the particular tone or personality may be injected into the initial version of the machine-learning model (e.g., the version of the machine-learning model after completion of the first training process) to cause the machine-learning model to generate natural language communications according to the particular tone or personality.

Response generation 336 may pass the natural language response to client device 140 via safety layer 312. Safety layer 312 may ensure the natural language response satisfies the safety rulesets (e.g., does not include inappropriate or offensive, inappropriate language such vulgar words, dangerous words, unrelated wors or phrases, etc.). For example, safety layer 312 may prevent generating communications that may offend the user or that may not be related to the task request.

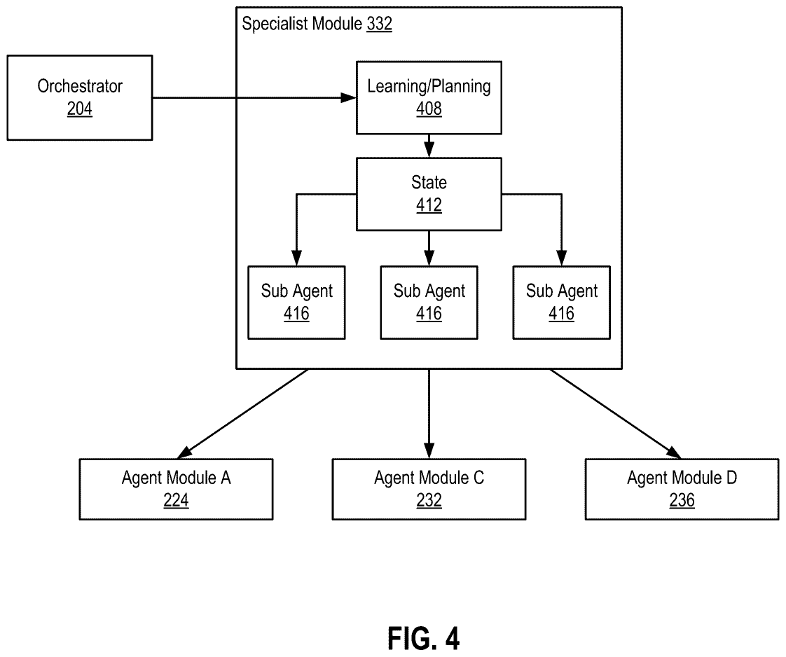

FIG. 4 illustrates a block diagram of an example specialist module layer of an AI Agent Platform according to aspects of the present disclosure. Specialist modules represent an intermediate layer of the AI Agent Platform (e.g., which may include one or more layers of specialist modules). Specialist modules receive tasks and context information associated with tasks (e.g., topics, intents, etc.) from orchestrator 204. For example, specialist module 332 may be a travel-based specialist module configured to execute travel-based tasks received from orchestrator 204. Specialist module 332 may include learning/planning 408, which may receive the task and context information and divide the task into a sequence of subtasks that can be implemented by one or more agent modules. Learning/planning 408 may include one or more algorithms and/or machine-learning models trained to break down tasks into subtasks that when implemented, implement the task.

The one or more algorithms and/or machine-learning models may be trained by the AI Agent Platform for particular types of tasks. For example, since specialist module 332 may is configured to execute travel-based tasks, the one or more algorithms and/or machine-learning models may be trained to execute trave-based tasks, such as, but not limited to, planning travel accommodations (e.g., airfare and/or train transportation, rental cars, hotels, etc.), booking travel accommodations (e.g., purchasing plane tickets, train tickets, etc.), planning activities, etc. The training data may be derived from one or more previous tasks executed by the AI Agent Platform, tasks executed by users of the AI Agent Platform (e.g., user agents, etc.), a database of tasks and subtasks, feedback associated with operations of the AI Agent Platform, combinations thereof, and/or the like.

Examples of machine-learning models usable by learning/planning 408 include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

The one or more algorithms and/or machine-learning models may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

Learning/planning 408 may include a set of instructions or machine-learning models that are trained to define the sequence of subtasks that will implement a task. Learning/planning 408 may schedule the execution of the sequence of subtasks in series, in parallel, a combination of in series and in parallel. For instance, subtasks with dependencies on the output of other subtasks may be executed sequentially (e.g., after the other subtasks). Subtasks that are not dependent on other subtasks can be executed at any time. These subtasks may be executed in series or in parallel with other subtasks.

Learning/planning 408 may define an execution order (e.g., the sequence) in subtasks are to be executed. The execution order may include sequential and/or parallel subtask execution. The execution order may be based on dependencies between the subtasks. The execution order may also be based on an execution efficiency (e.g., execution rate, resource utilization, etc.) or execution security (e.g., fault tolerance, etc.). For instance, learning/planning 408 may define the execution order of subtasks according to dependencies, then optimize the execution order to improve an execution rate (e.g., by executing any non-dependent-based subtasks in parallel with other subtasks), resource utilization (e.g., by executing subtasks sequentially to reduce a processing resource utilization, etc.), execution security (e.g., by executing subtasks in an order that reduces a likelihood of generating faults or in an order in which recovering from a fault is more likely, etc.), combinations thereof, and/or the like.

In some instances, learning/planning 408 may determine that a task cannot be divided into subtasks or that a task can be executed without dividing the task into subtasks. In those instances, specialist module 332 may execute the task directly (e.g., without invoking an agent module, etc.). For instance, specialist module 332 may execute the task directly by invoking one or more sub-agents 416, a machine-learning model of learning/planning 408, and/or another processor of specialist module 332. Learning/planning 408 may determine whether to cause specialist module 332 to execute a task directly or to invoke a specialist module to execute task. For instance, learning/planning 408 may include a classifier and/or decisioning module configured to determine how to route tasks including tasks that can be executed directly by specialist module 332. In some instances, learning/planning 408 may cause specialist module 332 to execute any task that specialist module 332 is capable of executing directly. In other instances, learning/planning 408 may determine whether to execute tasks directly, to pass tasks to an agent module, and/or break up a task into subtasks for agent modules. The determination may be based on whether specialist module 332 is capable executing the task directly, a task type, execution efficiency, execution security, and/or the like. For instance, learning/planning 408 may pass a task (or break up a task into subtasks) to increase a task execution rate, etc. In still yet other instances, learning/planning 408 may pass all tasks to agent modules regardless of whether specialist module 332 is capable of executing a task directly or if the task can be broken up into subtasks.

The sequence of subtasks may be output from learning/planning 408 to state 412. State 412 may store execution state of the task assigned to specialist module 332 and the state of subtasks defined by learning/planning 408. State 412 may also provide additional parameters to subtasks based on the context received from orchestrator 204, user input (e.g., from client device 140 and/or terminal devices), information derived from execution of subtasks, and/or the like. State 412 may be used to define a state machine for the task operation. The state machine facilitates learning for improved task execution, fault tolerance (e.g., error handling, etc.), memory tracking throughout subtasks (e.g., enabling subtasks to benefit from parameters derived from previous subtasks, etc.), etc.

The sequence of subtasks may be assigned to one or more sub-agents 416 or directly to agent modules (e.g., such as agent module A 224, agent module C 232, and agent module D 236, etc.). In some examples, specialist modules may operate as an orchestrator by assigning subtasks to subagents and/or other specialist modules that are too complex to be executed by agent modules. For example, if a subtask cannot be executed by an available agent module, specialist module 332 may assign the subtask to one or more sub-agents 416 or to another specialist module. One or more sub-agents 416 or to another specialist module, execute use learning/planning 408 to subdivide the subtasks into smaller subtasks that may be executed by agent modules (or further refined using subagents or other specialist modules).

Specialist module 332 may execute the sequence of subtasks by invoking agent modules. The sequence of subtasks may be executed in series, in parallel, and/or partially in series and partially in parallel depending on the task and/or subtasks. Agent modules may be trained to execute particular types of subtasks. In some instances, agent modules may be trained to execute a single type of subtasks. For example, an agent module may include or access a particular API to enable execution of functions to access particular webpages, subsystems, etc. Another agent module may include or access another particular API to enable execution of functions to access other particular webpages, subsystems, etc. Returning to the previous travel planning example, agent module A may be configured to retrieve information associated with an availability of the user such as calendar information, agent module C 232 may be configured to retrieve flight information to a target destination given the availability information, agent module D 236 may be configured to retrieve hotel information at the target destination given the availability information, etc.

Specialist module 332 may receive the information generated by agent modules as a result of execution of the sequence of subtasks and define a task response that includes the information. Specialist module 332 may return task response to orchestrator 204 (and/or the module that assigned the task to specialist module 332 if assigned by a subagent or other specialist module, etc.). Specialist module 332 may also use the task response to update the one or more algorithms and/or machine-learning models of learning/planning 408 (e.g., using reinforcement learning, etc.) to improve task subdivision and routing. In some examples, specialist module 332 may receive feedback from client device 140 and/or the user thereof, which may further improve the updating of the one or more algorithms and/or machine-learning models.

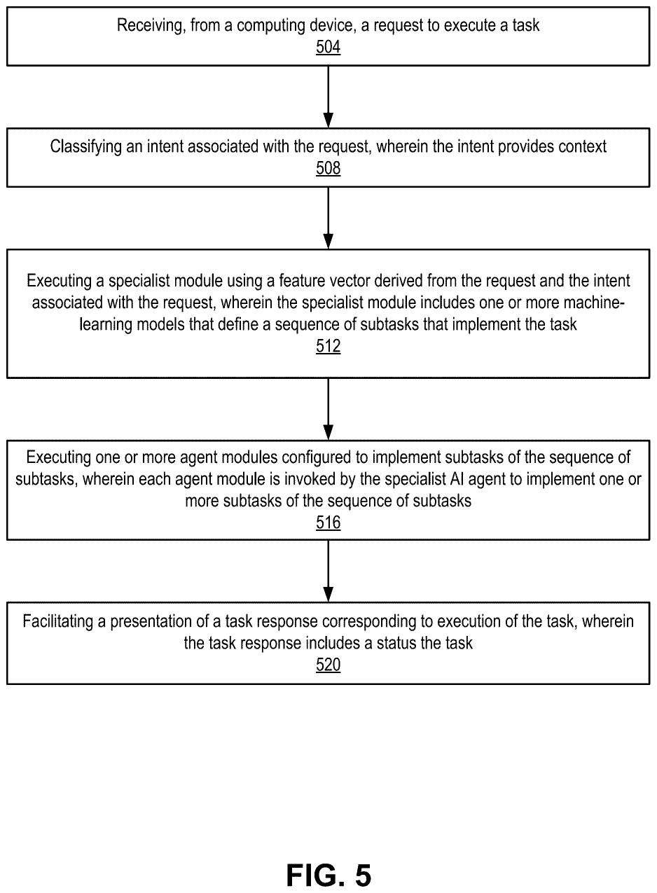

FIG. 5 illustrates a flowchart of an example process for identifying and executing tasks within communications according to aspects of the present disclosure. At block 504, a device (e.g., a processing device such as, but not limited to, a computing device, server, node of a network, etc.) of an AI Agent Platform may receive a request to execute a task from a computing device. The request may include natural language communications received over a text-based communication channel (e.g., a web-interface, a user interface of an application executed by the computing device, instant messaging, direct messaging, text messaging, email, etc.), a voice-based interface (e.g., user interface of an application executed by the computing device, a telephone connection, a voice-assistant device, etc.), an audiovisual interface (e.g., video conferencing, etc.), and/or the like. The communication channel may be between the computing device and the AI Agent Platform or between the computing device and a terminal device (e.g., operated by a user agent of the AI Agent Platform, etc.). The device may parse the request to identify the task (e.g., using keyword matching, a classifier, etc.).

If the AI Agent Platform does not have enough information to implement the classified task, the AI Agent Platform may request additional information from the computing device (e.g., over the same communication channel or another communication channel, etc.) or retrieve additional information accessible to the AI Agent Platform (e.g., such as any information or external sources that the computing device and/or the user thereof has been given authorization to access by the computing device and/or the user).

At block 508, the device may classify an intent associated with the request. The intent associated with the request provides a context that improves the task execution process. The context may include additional information associated with the request such as, but not limited to, features derived from previous communications between the computing device and the AI Agent Platform, preferences of the computing device and/or the user thereof, task type of the task, etc. For example, the request “I'd like to see the baseball game tonight” may include an intent to attend a baseball game. The AI Agent Platform may use topic segmentation and sentiment analysis to derive the intent of the request. In some examples, the AI Agent Platform includes one or more machine-learning models trained to identify one or more topics and/or one or more intents from the request. The one or more machine-learning models may output predicted topics and/or intents along with confidence values indicating a degree in which the output topics and/or intents fit the internal weights of the one or more machine-learning models. The confidence values are indicative of an accuracy of the predictions. The AI Agent Platform layer may select the topics and/or intents that are greater than a threshold confidence value.

At block 512, the device may execute a specialist module using an object (e.g., a feature vector, a data structure such as a JavaScript Object Notation (JSON) object, etc.) derived from the request and the intent associated with the request. In some examples, the specialist module may be or include the components of specialist module 332 of FIG. 3 and FIG. 4. In some implementations. the specialist module may include one or more machine-learning models that define a sequence of subtasks that implement the task. In other implementations, the specialist module may use deterministic techniques to define the sequence of subtasks based on an identification of the task, a task type corresponding the task, the intent, a topic, combinations thereof, and/or the like. In some instances, the object may be further derived from state information provided by the AI Agent Platform. The state data may include information associated with related tasks being executed by this specialist module and/or other specialist modules, recent communications between the AI Agent Platform and the computing device and/or the user thereof, preferences associated with the computing device and/or the user thereof, recent operations of the AI Agent Platform related to the computing device and/or the user thereof, and/or any other recent information collected or generated by the AI Agent Platform and associated with the computing device and/or the user thereof. The state data may be passed to the specialist modules so that each specialist module may determine the execution state of the overall task as well as the execution state of the tasks assigned to other specialist modules.

Specialist modules may be trained to execute a discrete set of task types associated with a domain. The AI Agent Platform may include one or more different specialist modules that may each be invoked to execute various task types. Each specialist module may include a planning component, a state component, and one or more subagents. The planning component is configured to break down tasks into subtasks and then defines a sequence of subtasks that when executed, implement the task. The planning component may also include a scheduler that coordinates execution of particular tasks or subtasks with other specialist modules that are executing other portions of a larger task. The state component tracks the state of the task and the sequence of subtasks. The state component may form a state machine for the specialist module usable to provide fault tolerant processing of tasks, maintain features of tasks for future subtasks, provide an execution history (e.g., enabling the execution of a task or subtask to be created, etc.), etc.

In some instances, two or more specialist agents may be invoked to execute a complex task. For example, the AI Agent Platform may receive a task that cannot be executed by a particular specialist agent (e.g., a complex task, etc.). An orchestrator (e.g., such as orchestrator 204, etc.) may divide the complex task into two or more tasks that can be executed by the specialist agents of the AI Agent Platform. The orchestrator may also perform scheduling (e.g., determining which task is to be assigned to which specialist agent, when each task is to be assigned to that specialist agent, etc.) and track state information (e.g., state 328 and/or in same or similar manner as state 412 of the specialist modules, etc.) to enable passing information generated between tasks of the complex task. The orchestrator may aggregate the task responses received from the specialist module to output a task response of the complex task.

The subagents include instructions that implement particular subtasks. The subagents may also include instructions for coordinating agent modules that execute the subtasks, formatting execution details, generating communications (e.g., such as requests for particular information, execution details, etc.). In some examples, subagents may include machine-learning models to provide any of the aforementioned functionality. In other instances, subagents may include predefined instruction sets that may provide any of the aforementioned functionality. In still yet other examples, subagents may be configured by the one or more machine-learning models.

At block 516, the device may execute one or more agent modules to implement the subtasks of the sequence of subtasks. Each agent module may be executed by a specialist module to implemented one or more of the subtasks. Agent modules may be lightweight agents that are configured to execute a single subtask type or a limited set of related subtask types. In some examples, the agent module includes instructions to facilitate execution of subtasks corresponding to the single subtask type or set of related subtask types. In other examples, the agent module includes a machine-learning model trained to facilitate execution of subtasks corresponding to the single subtask type or set of related subtask types.

The agent module may include access to one or more APIs usable to invoke internal services (e.g., services and/or functions of the AI Agent Platform, etc.) and/or external services (e.g., services external to the AI Agent Platform such as, but not limited to, web-based services, third-party services, remote computing devices, etc.). For instance, the APIs may be usable to access a flight booking platform to identify available flights and/or to book a flight for a user. Agent modules may be chained together by specialist modules to execute various subtasks that correspond to a task. Agent modules may also include error instructions (e.g., generate and/or handle errors, exceptions, faults, interrupts, etc.), retry instructions (e.g., to restart a subtask upon detecting an error condition, a stalled condition, etc.), a tool registry (e.g., that stores information associated with libraries, APIs, tools, etc. that can be invoked by the agent module) , and/or the like.

The specialist module may invoke agent modules based on a particular subtask of the sequence of subtasks. As a result, the specialist module may invoke the same agent module for each subtask or different agent modules for each subtask depending on the subtask. The specialist module may execute multiple agent modules with each agent module implementing a one or more of the subtasks. The subtasks may be executed in series, in parallel (e.g., according to the sequence, etc.), or partially in series and partially in parallel based dependencies between subtasks of the sequence of subtasks.

The agent module may return execution details corresponding to execution of the subtask. The execution details may provide an indication of whether the subtask executed successfully or unsuccessfully, state information associated with the subtask, information generated and/or retrieved as a result of executing the subtask, etc. For example, some subtask may be executed to generate or retrieve information for the user (and/or other tasks or subtasks, etc.). The execution details for those subtasks may include the generated or retrieved information. Other subtask may generate a tangible result such as acquire objects or services, etc. The execution details for those subtasks may include confirmation of the acquisition of the object and/or service (e.g., tracking numbers for mailed objects, serial numbers of acquired objects, confirmation webpages generated upon checkout or acquisition, receipts, etc.).

If there is another subtask in the sequence of subtasks, then the specialist module may invoke an agent module (e.g., the same agent module or another agent module depending on a subtask type associated with the next subtask) to execute the next subtask in the sequence of subtasks. If there are no other subtasks in the sequence of subtasks, the specialist module defines a task response based on the execution details of each subtask. The task response may a form of execution details for the task. For example, generation tasks may be executed to generate or retrieve information for the user (and/or other tasks or subtasks, etc.). The task response for those tasks may include the generated or retrieved information. Acquisition tasks may be associated with a tangible result such as acquisition of objects or services, etc. The task response for those tasks may include confirmation of the acquisition of the object and/or service (e.g., tracking numbers for mailed objects, serial numbers of acquired objects, confirmation webpages generated upon checkout or acquisition, receipts, etc.). Some tasks may hybrid tasks (e.g., include aspects of generation tasks and aspects of acquisition tasks). The task response for hybrid tasks may include the same types of information as the task response for generation tasks and the task response for acquisition tasks. The specialist module returns the task response to the orchestrator layer (e.g., and/or the component of the AI Agent Platform that assigned the task to the specialist module).

For example, a request to execute a task may include a travel request such “I want to visit Denver in September.” The specialist module defines the sequence of subtasks that include a first subtask to acquire calendar information from a calendar service associated with the user, a second subtask to acquire preference of the user (e.g., directly from the user through a communication request to the user or a user agent of the AI Agent Platform, stored preferences, preference generated from previous interactions with the AI Agent Platform, etc.), a third subtask to identify candidate flights based on the calendar and preferences of the users, a fourth subtask to identify candidate hotels based on the calendar and preferences, a fifth subtask to identify potential activities in Denver based on the calendar and preferences, etc. The task response may include a complete itinerary for a trip to Denver sometime in September based on the availability of the user (as determined by the user's calendar).

At block 520, the AI Agent Platform may facilitate a presentation of the task response corresponding to execution of the task. The task response may include a status of the task. For example, if the task executed successfully, the task response may indicate the task executed successfully and provide details of the executed task (e.g., any information of the task response and/or execution details of agent modules, etc.). If the task did not execute successfully, the task response may include an indication of why the task failed, which subtask caused the task to fail, an identification of one or more errors generated, etc. In some instances, the status of the task and/or any subtask may be communicated to the computing device at any stage of task execution such as, but not limited to, when the sequence of tasks is generated, during or after executing a subtask (e.g., a block 512, block 516, and/or block 520).

The AI Agent Platform may include a natural language generator configured to generate natural language communications to communicate the task response to the user. The natural language generator may generate communications based on the communication channel over which the request was received. That is, if the request is received via instant messaging, the task response may be communicated over instant messaging. Alternatively, the task response may be communicated over another communication channel (e.g., such as any of the aforementioned communication channels). The communications generated by the natural language generator may be processed by the safety layer before being transmitted to the computing device to ensure the generated response is safe to transmit (e.g., does not violate any content restrictions such as improper words or phrases, topics, etc.). Once presented to the user, the AI Agent Platform may standby for further input (e.g., to execute further tasks, etc.) from the computing device.

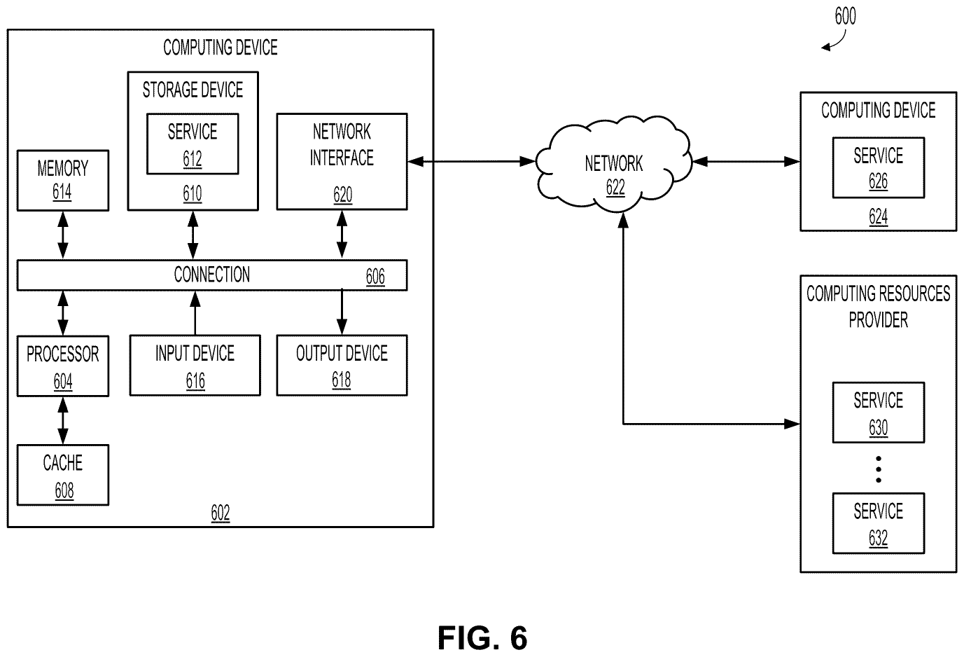

FIG. 6 illustrates an example computing device architecture of an example computing device that can implement the various techniques described herein according to aspects of the present disclosure. The example computing system 600 illustrated in FIG. 6 includes a computing device 602, which has various components in electrical communication with each other using a connection 606, such as a bus, in accordance with some implementations. The example computing system 600 includes a processor 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system 600 includes a cache 608 of high-speed memory connected directly with, in close proximity to, or integrated as part of the processor 604. The computing system 600 can copy data from the system memory 614 and/or the storage device 610 to the cache 608 for quick access by the processor 604. In this way, the cache 608 can provide a performance boost that decreases or eliminates processor delays in the processor 604 due to waiting for data. Using modules, methods and services such as those described herein, the processor 604 can be configured to perform various actions. In some embodiments, the cache 608 may include multiple types of cache including, for example, level one (L1) and level two (L2) cache. The system memory 614 may be referred to herein as system memory or computer system memory. The system memory 614 may include, at various times, elements of an operating system, one or more applications, data associated with the operating system or the one or more applications, or other such data associated with the computing device 602.

Other system memory can be available for use as well. The memory can include multiple different types of memory with different performance characteristics. The processor 604 can include any general-purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system 600, the storage device 610 can be connected to other parts of the computing device 602 using the connection 606. In some embodiments, a hardware service or hardware module such as service 612, that performs a function can include a software component stored in a non-transitory computer-readable medium that, in connection with the necessary hardware components, such as the processor 604, connection 606, cache 608, storage device 610, system memory 614, input device 616, output device 618, and so forth, can carry out the functions such as those described herein.

The disclosed systems and services can be performed using a computing system such as the example computing system illustrated in FIG. 6, using one or more components of the example computing system 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 604 wherein the code is stored in memory such as system memory 614 as described herein. One or more of a user device, a provider server or system, a database system, or other such devices, services, or systems may include some or all of the components of the computing system such as the example computing system illustrated in FIG. 6, using one or more components of the example computing system 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The system memory 614 can be coupled to the processor 604 by, for example, a connector such as connection 606, or a bus. As used herein, a connector or bus such as connection 606 is a communications system that transfers data between components within the computing device 602 and may, in some embodiments, be used to transfer data between computing devices. The connection 606 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The system memory 614 can include random access memory (RAM) including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The system memory 614 can also include magnetic or optical data storage media including read-only (e.g., CD ROM and DVD ROM) or otherwise (e.g., CD or DVD). The memory can be local, remote, or distributed.

As described above, the connection 606 (or bus) can also couple the processor 604 to the storage device 610, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as system memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g., network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the one or more services 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving, from a computing device, a request to execute task; classifying an intent associated with the request, wherein the intent provides context; executing a specialist module using an object derived from the request and the intent associated with the request, wherein the specialist module includes one or more machine-learning models that define a sequence of subtasks that implement the task; executing one or more agent modules configured to implement the subtasks of the sequence of subtasks, wherein each agent module is invoked by the specialist AI agent to implement one or more subtasks of the sequence of subtasks; and facilitating a presentation of a task response corresponding to execution of the task, wherein the task response includes a status the task.

Example 2 is the method of example(s) 1, wherein the request is received as a natural language communication.

Example 3 is the method of example(s) 1, wherein the task response includes a natural language communication.

Example 4 is the method of example(s) 1, further comprising: processing the request through a safety layer, wherein the safety layer determines that specialist module is capable of processing task execution, wherein executing a specialist module is in response to processing the request through the safety layer.

Example 5 is the method of example(s) 1, wherein the object is further derived from state data, wherein the state data includes features from previous requests related to the task.

Example 6 is the method of example(s) 1, wherein the specialist module tracks an execution state of each agent module.

Example 7 is the method of example(s) 1, wherein the task response includes a current execution state of the task.

Example 8 is the method of example(s) 1, wherein the task response includes a current execution state of one or more subtasks of the sequence of subtasks.

Example 9 is the method of example(s) 1, wherein the task response includes a summary of the execution of the task.

Example 10 is the method of example(s) 1, further comprising: processing the task response through a safety layer before facilitating the presentation of the response, wherein the safety layer evaluates the task response to determine whether the task response w violates a safety ruleset.

Example 11 is the method of example(s) 1, wherein a first agent module accesses an application programming interface to facilitate implementation of a subtask by an external service.

Example 12 is a system comprising: one or more processors; a non-transitory computer-readable medium storing instructions that when executed by the one or more processors, cause the one or more processors to perform the methods of any of example(s)s 1-11.

Example 13 is a non-transitory computer-readable medium storing instructions that when executed by one or more processors, cause the one or more processors to perform the methods of any of example(s)s 1-11.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving, from a computing device, a request to execute a task;
classifying an intent associated with the request, wherein the intent provides context;
executing a specialist module using an object derived from the request and the intent associated with the request, wherein the specialist module includes one or more machine-learning models that define a sequence of subtasks that implement the task;
executing one or more agent modules configured to implement subtasks of the sequence of subtasks, wherein each agent module is invoked by the specialist module to implement one or more subtasks of the sequence of subtasks; and
facilitating a presentation of a task response corresponding to execution of the task, wherein the task response includes a status the task.

2. The method of claim 1, wherein the request is received as a natural language communication.

3. The method of claim 1, wherein the task response includes a natural language communication.

4. The method of claim 1, further comprising:
processing the request through a safety layer, wherein the safety layer determines that specialist module is capable of processing task execution, wherein executing a specialist module is in response to processing the request through the safety layer.

5. The method of claim 1, wherein the object is further derived from state data, wherein the state data includes features from previous requests related to the task.

6. The method of claim 1, wherein the specialist module tracks an execution state of each agent module.

7. The method of claim 1, wherein the task response includes a current execution state of the task.

8. A system comprising:
one or more processors; and
a non-transitory computer-readable medium storing instructions that when executed by the one or more processors, cause the one or more processors to perform operations including:
receiving, from a computing device, a request to execute a task;
classifying an intent associated with the request, wherein the intent provides context;
executing a specialist module using an object derived from the request and the intent associated with the request, wherein the specialist module includes one or more machine-learning models that define a sequence of subtasks that implement the task;
executing one or more agent modules configured to implement subtasks of the sequence of subtasks, wherein each agent module is invoked by the specialist module to implement one or more subtasks of the sequence of subtasks; and
facilitating a presentation of a task response corresponding to execution of the task, wherein the task response includes a status the task.

9. The system of claim 8, wherein the request is received as a natural language communication.

10. The system of claim 8, wherein the task response includes a natural language communication.

11. The system of claim 8, wherein the operations further include:
processing the request through a safety layer, wherein the safety layer determines that specialist module is capable of processing task execution, wherein executing a specialist module is in response to processing the request through the safety layer.

12. The system of claim 8, wherein the object is further derived from state data, wherein the state data includes features from previous requests related to the task.

13. The system of claim 8, wherein the specialist module tracks an execution state of each agent module.

14. The system of claim 8, wherein the task response includes a current execution state of the task.

15. A non-transitory computer-readable medium storing instructions that when executed by one or more processors, cause the one or more processors to perform operations including:
receiving, from a computing device, a request to execute a task;
classifying an intent associated with the request, wherein the intent provides context;
executing a specialist module using an object derived from the request and the intent associated with the request, wherein the specialist module includes one or more machine-learning models that define a sequence of subtasks that implement the task;
executing one or more agent modules configured to implement subtasks of the sequence of subtasks, wherein each agent module is invoked by the specialist module to implement one or more subtasks of the sequence of subtasks; and
facilitating a presentation of a task response corresponding to execution of the task, wherein the task response includes a status the task.

16. The non-transitory computer-readable medium of claim 15, wherein the request is received as a natural language communication.

17. The non-transitory computer-readable medium of claim 15, wherein the task response includes a natural language communication.

18. The non-transitory computer-readable medium of claim 15, wherein the operations further include:
processing the request through a safety layer, wherein the safety layer determines that specialist module is capable of processing task execution, wherein executing a specialist module is in response to processing the request through the safety layer.

19. The non-transitory computer-readable medium of claim 15, wherein the object is further derived from state data, wherein the state data includes features from previous requests related to the task.

20. The non-transitory computer-readable medium of claim 15, wherein the specialist module tracks an execution state of each agent module.
